(19) United States
(12) Patent Application Publication
(10) Pub. No.: US 2005/0229940 A1
(43) Pub. Date: Oct. 20, 2005

(54) Conveying arrangement for a machine of the tobacco-processing industry

(75) Inventors: Peter Funke, Hamburg (DE); Torsten Grigutsch, Hamburg (DE); Dietmar Zielke, Hamburg (DE); Tim Ullner, Hamburg (DE)

Correspondence Address: VENABLE LLP, P.O. BOX 34385, WASHINGTON, DC, 20045-9998, US

(73) Assignee: HAUNI PRIMARY GMBH, Hamburg (DE)

(21) Appl. No.: 11/106,615

(22) Filed: Apr. 15, 2005

(30) Foreign Application Priority Data
Apr. 15, 2004 (DE) 10 2004 018 879.3

(51) Int. Cl. B41J 29/377; A24B 7/14

(52) U.S. Cl. 131/109.1; 131/108

(57) ABSTRACT

The application relates to a conveying arrangement for a machine in the tobacco-processing industry having a conveying apparatus which has a plurality of conveying elements moving in a conveying direction for conveying and/or separating a fibrous product and is characterised in that in the region of the conveying elements the conveying arrangement comprises at least one fixed nozzle for blowing in a medium in a direction counter to the conveying direction.

### CROSS-REFERENCE TO RELATED APPLICATION

This application claims the priority of German Patent Application No. 10 2004 018 879.3 filed Apr. 15, 2004, the subject matter of which is incorporated herein by reference. The disclosure of all U.S. and foreign patents and patent applications mentioned below are also incorporated herein by reference.

### BACKGROUND OF THE INVENTION

The invention relates to a conveying arrangement for a machine of the tobacco-processing industry having a conveying apparatus which has a plurality of conveying elements moving in a conveying direction for conveying and/or separating a fibrous product.

EP 0 895 721 B1 discloses a rotating Winnover roller at the tobacco inlet of a pneumatic conveying dryer for applying a conditioning medium to the tobacco material. In some sorts of tobacco the loosening effect of the Winnover roller may not be sufficient which in certain circumstances may give rise to clotting of the tobacco and non-uniform drying of the tobacco.

DE 100 08 961 A1 discloses a separating apparatus having rotating rakes, wherein from air nozzles arranged at the periphery of the rake tines and constructed in the form of hollow pegs jets of blast air emerge in order to reinforce the dividing effect of the rake tines.

### SUMMARY OF THE INVENTION

The object of the present invention consists in providing a conveying arrangement by means of which improved separating of product fibres can be achieved.

The invention solves this object in particular in that the conveying arrangement has in the region of the conveying elements at least one fixed nozzle for blowing in a medium in a direction opposite to the conveying direction. The medium blown in exerts a shear force on the product carried along by the conveying elements which brings about separation of the product fibres.

The medium blown in can be a stream of gas, composed in particular of air, water vapour or a mixture thereof or another suitable medium. In a preferred embodiment the medium can serve for spraying in a conditioning medium for the product in liquid or gaseous form or a mixture thereof. A preferred conditioning medium is water vapour. Other possible conditioning media are, for example, carbon dioxide, aroma-producing substances used in the tobacco industry, dressings consisting of solids dissolved in liquid such as, for example, sugar, moisture-retention agents such as, for example, glycol, or pure gases such as, for example, nitrogen, or a mixture of these media.

The conveying apparatus can serve for conveying or for separating the product. The term conveying apparatus accordingly also encompasses a separating apparatus whose main function lies in separating the product fibres. In a rotating conveyor the conveying direction is generally the circumferential direction. The outlet direction of the medium emerging from the nozzle is accordingly directed substantially counter to this circumferential direction.

The arrangement of the nozzle in the region of the conveying elements means that the medium emerging from the nozzle substantially strikes the product carried along by the conveying elements. Preferably, the nozzle is arranged in the region of a free end of the conveying elements in order to blow off the product from the conveying elements and by this means to improve the separating action.

“Fixed nozzle” means fixed relative to the conveying arrangement or to a housing surrounding the conveying apparatus. By this means, the invention is delimited with respect to nozzle openings in the moving conveying elements themselves as in DE 100 08 961 A1, or in parts of the conveying apparatus moving along with the conveying elements as in the nozzles in the roller member of the Winnover roller, for example, as described in EP 0 895 721 B1. These known nozzles are not suitable for achieving the separating effect according to the invention on the tobacco fibres. The fixed nozzle according to the invention can be arranged on a housing surrounding the conveying apparatus, but this is not necessarily the case.

The invention is preferably applied to a rotating conveying apparatus having radially extending conveying elements in order to improve the separating effect due to the conveying elements. The invention, however, is not restricted to rotating conveying apparatuses. It is also conceivable, for example, to apply it to a linear conveyor, a conveyor belt for instance, having conveying rakes extending over the width of the belt. Furthermore, the invention is preferably applied to a conveying apparatus constructed as a conditioning apparatus for applying a conditioning medium to the product.

### BRIEF DESCRIPTION OF THE DRAWINGS

Other advantageous characteristics emerge from the subsidiary claims and the following description of advantageous exemplified embodiments with reference to the attached drawing. This shows:

FIG. 1 a schematic illustration of a conveying arrangement in the region of a rotating conveying apparatus.

### DETAILED DESCRIPTION OF THE INVENTION

A conveying arrangement 10 comprises a closed conveying channel 22 for conveying a tobacco product 13 entering at 24 through the opening 18 into a pneumatic conveying dryer 17. Arranged in the conveying channel 22 is a conveying apparatus in the form of a rotating Winnover roller 11. Arranged on the roller member 16 are axial rows of tine-shaped radial pegs 12 which form rotating rakes in order to loosen or to separate the tobacco product 13 by mechanical action. The direction of rotation of the Winnover roller 11 is accordingly the conveying direction F of the tobacco product 13 in the region of the Winnover roller 11. The roller member 16 and/or the pegs 12 can be of hollow construction and be provided with nozzle openings for applying a conditioning medium to the tobacco product as described in EP 0 895 721 B1 and DE 100 08 961 A1.

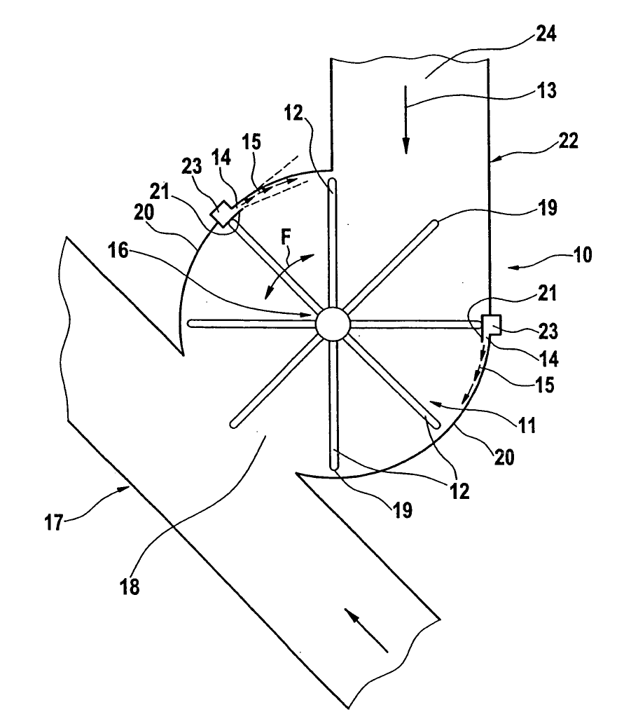

The Winnover roller 11 is surrounded by a housing 20 forming part of the conveying channel 22. Arranged on the housing 20 are nozzles 14 through which a stream of gas 15 is blown in substantially tangentially into the interior of the housing 20. Instead of the two nozzles 14 shown, just one or a plurality of nozzles 14 can be provided along the perimeter of the Winnover roller 11. The nozzles 14 can be constructed as a strip of nozzles, i.e. in an axially parallel nozzle channel 23 extending over the axial width of the Winnover roller 11. This can be a plurality of nozzles 14 extending over the nozzle channel 23 or one or more elongated nozzles 14 extending over the nozzle channel 23. The nozzle channel 23 is supplied with compressed air, for example, so that the air emerging from the nozzles 14 forms a stream of air 15 which is oriented approximately tangentially to the envelope or the fictitious outer perimeter of the Winnover roller 11 and hence approximately counter to the conveying direction F. The stream of air 15 is directed substantially into the region illustrated by dotted lines in FIG. 1 which can, for example, have an aperture angle of 15°. To produce this directed counterflow additional guide means 21, deflector plates, for example, can be provided at the aperture of the nozzles 14. This, however, is not absolutely essential. The stream of air 15 strikes the tobacco product 13 carried along in particular by the free ends 19 of the pegs 12 and exerts shear forces on it, which bring about loosening, separation and homogenisation of the fibres of the tobacco product 13. By this means, more uniform drying of the tobacco product 13 in the pneumatic conveying dryer 17 and hence an improved drying result can be achieved.

The stream of air 15 brushes along the inside wall of the housing 20 and in this way prevents deposition of tobacco material on the inner wall of the housing 20, whereby, as a further advantage of the invention, downtimes due to necessary cleaning of the inner wall of the housing 20 can be reduced.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. Conveying arrangement for a machine in the tobacco-processing industry having a conveying apparatus which has a plurality of conveying elements moving in a conveying direction for conveying and/or separating a fibrous product,
characterised in that in the region of the conveying elements the conveying arrangement comprises at least one fixed nozzle for blowing in a medium in a direction counter to the conveying direction.

2. Conveying arrangement according to claim 1, characterised in that the conveying apparatus is of rotary construction with radially extending conveying elements.

3. Conveying arrangement according to claim 2, characterised in that the rotating conveying apparatus is a Winnover roller arranged at the tobacco inlet of a pneumatic conveying dryer.

4. Conveying arrangement according to claim 2, characterised in that the nozzle is arranged in such a way that the inlet direction of the medium is oriented approximately tangentially to the fictitious outer circumference of the rotating conveying apparatus.

5. Conveying arrangement according to claim 1, characterised in that the nozzle is arranged on a housing surrounding the conveying apparatus.

6. Conveying arrangement according to claim 1, characterised in that the nozzle is constructed as a nozzle strip.

7. Conveying arrangement according to claim 1, characterised in that the conveying elements are peg-shaped.

8. Conveying arrangement according to claim 1, characterised in that the nozzle is arranged in the region of a free end of the conveying elements.

9. Conveying arrangement according to claim 1, characterised in that the medium comprises a gaseous component preferably composed of air, water vapour or a mixture thereof.

10. Conveying arrangement according to claim 1, characterised in that the medium contains a conditioning medium in liquid or gaseous form or a mixture thereof.

11. Conveying arrangement according to claim 1, characterised in that the conveying device is a conditioning device for applying a conditioning medium to the product.
